(19) United States
(12) Patent Application Publication
(10) Pub. No.: US 2012/0074664 A1
(43) Pub. Date: Mar. 29, 2012

(54) Market Basket System

(76) Inventors: Paul Henny, Roanoke, VA (US); M. Joyce Henny, Portage, MI (US)

(21) Appl. No.: 12/980,046

(22) Filed: Dec. 28, 2010

Related U.S. Application Data
(60) Provisional application No. 61/387,799, filed on Sep. 29, 2010.

(51) Int. Cl. B62B 1/04; B60R 7/00

(52) U.S. Cl. 280/35; 224/411

(57) ABSTRACT

A modular basket system, accompanying hand cart, and method for collecting and transporting grocery items. A series of rectangular baskets placed inside a standard shopping cart provide storage and organization for groceries while shopping. Handles on the baskets allow easy transfer in and out of the shopping cart. Optionally, a collapsible hand cart provides a means to secure the baskets and transport them without a standard grocery cart. The hand cart is a two-wheeled structure that movably supports load, and comprises a collapsible handle and foldable frame for improved storage. The baskets may be additionally lined with removable bags or insular liners to preserve frozen foods between the market and home.

### CROSS REFERENCE TO RELATED APPLICATION

This application claims the benefit of U.S. Provisional Application No. 61/387,799 filed on Sep. 29, 2010, entitled “Market Basket System”

### BACKGROUND OF THE INVENTION

1. Field of the Invention

The present invention relates to grocery transport baskets and collapsible hand carts for improved collection and transport of grocery items.

2. Description of the Prior Art

Traditional methods of grocery shopping include use of a store-owned hand basket or shopping cart. Organization and separation of food within these structures is nearly impossible, causing cold items to mix with warm ones, and hazardous cleaning supplies to be placed next to edible food. Items are often placed in a common area until check-out, leading to damaged goods or contaminated food products.

After collecting and paying for the desired groceries, the items are generally placed in non-recyclable plastic bags for transportation home. These bags are extremely harmful to the environment, as most are made from material not readily disposable in an eco-friendly manner. Additionally, they tend to be composed of very thin material, which does not support load imparted from heavy or multiple-contained items. This necessitates the need to either double-bag or place fewer items in each bag, both of which increase material usage and eventual waste. Optionally-requested paper bags are sometimes used, which are often supported with an exteriorly-wrapped plastic bag. However, these bags do not provide adequate lateral support for groceries in transport, allowing items to escape or spill out. This is especially true while transporting plastic bagged or paper bagged items in a vehicle, where sudden changes in momentum cause items to shift suddenly.

Traditional methods of collecting and transporting groceries are both inefficient and potentially harmful. In addition to the environmental concerns of grocery bags, the carts used to transport articles of food within the store can be problematic. First, they are commonly stored outdoors, which can leave them covered in dirt and residue, which is a health risk for transporting food. Secondly, they are generally well-used, and often do not function as intended. Wheels are frequently dysfunctional and cause the cart to steer awkwardly, and their upper trays do not always extend properly if damaged. Additionally, the carts must be returned to the store after being used, which involves taking the cart to a collection point or leaving it in the parking lot for others to avoid.

Several solutions to these problems have been suggested in the art. U.S. Pat. No. 4,560,096 to Lucas describes a shopping cart-attachable bag system that is useful for storing and organizing retail items. The bags in this patent are comprised of flexible sheet material with lift handles and optionally attachable support members for the rails of the shopping cart. While these are useful for organizing items within a shopping cart, there are no means for containing or supporting the purchased items while transporting the bags home in a car. The flexible bags provide no lateral support, and can lead to spilled or damaged items.

Patents with similar drawbacks include U.S. Pat. No. 5,533,361 to Halpren, which describes an insulated cooler for keeping groceries cold while shopping. This cooler also comprises flexible walls, along with attachment means for a standard shopping cart. Similar to the aforementioned patents, this bag also does not provide adequate support for securely transporting groceries outside of a shopping cart. U.S. Pat. No. 7,270,338 to Edgar describes an insulated compartment for frozen items within a grocery cart, in which an open container is fit snugly inside the forward frame of the cart. The open section of this container does not properly organize and secure items either while shopping or transporting the products in a vehicle.

Several patents exist which describe modular hand carts or dollies, which can be used to move heavy loads using a plurality of wheels and an extended handle. The devices described in the art are useful for stackably hauling goods, however most are not convenient or useful for shopping for groceries, specifically those delicate items which may crush if stacked. U.S. Pat. No. 6,131,927 to Krawczyk and U.S. Pat. No. 7,044,484 to Wang describe hand carts with these drawbacks. Grocery basket attachments along the rails of these carts are not described, which would separate items and prevent them from crushing one another.

Still Other known devices in the field of shopping cart systems include those with combined shopping baskets and carts. These tend to be bulky devices with minimal collapsibility, which limits a consumer's willingness to use them for everyday shopping. These devices include U.S. Pat. No. 5,203,578 to Davidson and U.S. Pat. No. 7,703,776 to Nugent. These patents use baskets to collect products, and a cart device to transport these items. However the carts themselves do not substantially collapse, and are therefore less practical for everyday use.

### SUMMARY OF THE INVENTION

In view of the foregoing disadvantages inherent in the known types of combination hand cart and grocery basket systems now present in the prior art, the present invention provides a new combination hand cart and grocery basket system wherein the same can be utilized for providing convenience for the user when collecting and transporting groceries in the marketplace and on the way home.

It is therefore an object of the present invention to provide a basket suitable for use within a traditional shopping cart for collecting and organization of items, and one which can be outfitted with insular or cloth bag liners.

Another object of the present invention is to provide a collapsible hand cart suitable for attaching grocery baskets for improved mobility and transport of products in the store and on the way home.

Yet another object of the present invention is to provide a method of grocery shopping that includes using a hand cart and basket system that utilizes no non-reusable material and provides improved collection and transport qualities through product check-out and return home.

Other objects, features and advantages of the present invention will become apparent from the following detailed description taken in conjunction with the accompanying drawings.

### BRIEF DESCRIPTIONS OF THE DRAWINGS

FIG. 1 shows a forward view of the market basket system, wherein the baskets are attached to a collapsible hand cart.

FIG. 2 shows a side view of the market basket system, including the method of attachment for the baskets a detailed view of the hand cart.

FIG. 3 shows an embodiment of the market basket system, wherein the baskets are utilized independently of the hand cart for collecting and organizing grocery items within a standard shopping cart.

FIG. 4 shows a side view of the hand cart without the attached market baskets.

FIG. 5 is an angled view of the hand cart in is collapsed state.

### DETAILED DESCRIPTION OF THE INVENTION

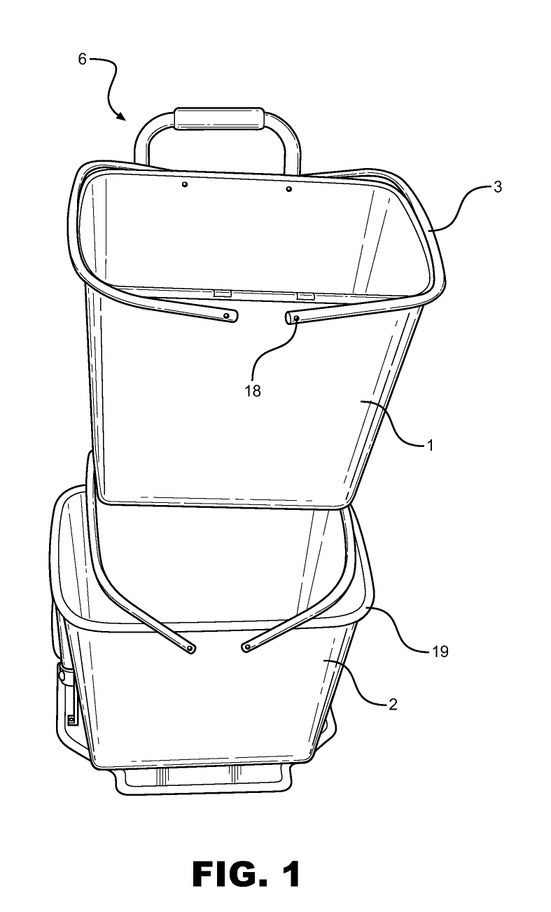

Referring now to FIG. 1, there is shown a forward view of the first embodiment of the market basket system. Two market baskets 1 and 2 are removably attached to a hand cart 6. The baskets 1 and 2 are stacked vertically and with a gap between them to allow for placement of items in either basket while attached to the hand cart 6. A plurality of handles 3 on each basket 1 and 2 allow the user to easily remove and transport the baskets 1 and 2 in either a filled or empty condition. The handles 3 rotate about their connection to the baskets 18 to form a unified handle above each basket 1 and 2 for the user. The baskets 1 and 2 are composed of a lightweight material such as plastic, wicker or other common material such as decorative wire. The baskets 1 and 2 may also be perforated for ventilation and visibility or be solid in structure, as shown in the figure. Lips 19 on the upper portion of each basket 1 and 2 allow for another grip point for the user for moving the baskets, and a ledge to tuck an interiorly placed cloth or insular liner 7 around the rim of the baskets 1 and 2.

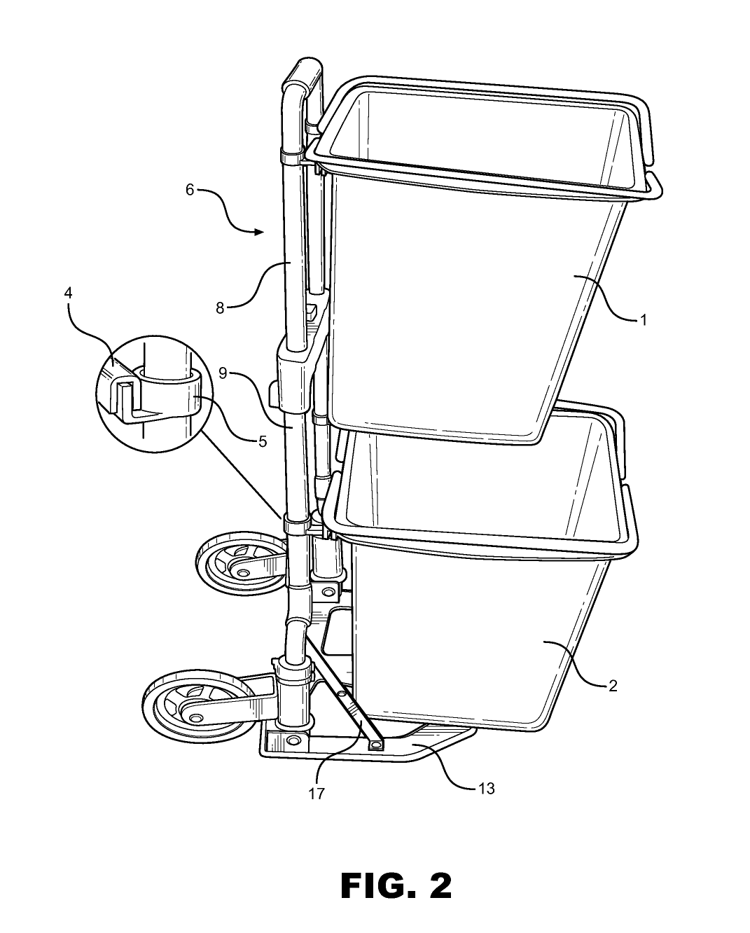

Referring now to FIG. 2, there is shown a side view of the first embodiment of the market basket system. Two market baskets 1 and 2 are supported by a hand cart 6. Both baskets 1 and 2 are supported using a latch device 5 which is secured circumferentially around the upper and lower rails 8 and 9 of the hand cart 6. Mounted on the back side of each basket 1 and 2 is a U-shaped attachment bar 4, which mates securely with the hand cart latches 5 to support load from the baskets 1 and 2 and their contents. The lower basket 2 is supported by this bar and latch device 4 and 5 as well as the base platform 13 of the hand cart. Removable braces 17 on the outboard edges of the base platform 13 increase the structural stability of the platform while preventing it from folding in on itself. The additional support from the base platform 13 and the braces 17 provides the lower basket 2 with a larger allowable weight capacity than the upper basket 1, as less stress is placed on the bar and latch device 4 and 5.

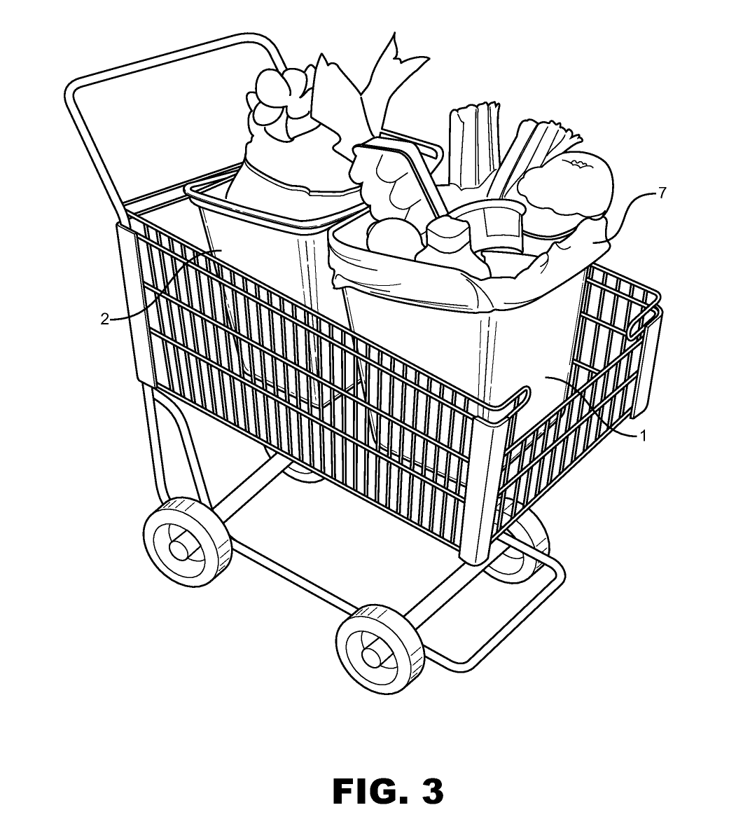

Referring now to FIG. 3, there is shown the second embodiment of the market basket system in which the market baskets 1 and 2 are utilized independently from the hand cart 6. The baskets 1 and 2 fit into a standard shopping cart to organize and separate items while shopping. Interior liners 7 may be optionally placed inside the baskets 1 and 2 to keep them clean, allow easy removal of the groceries once back home, as well as add insulation to the baskets 1 and 2 to keep frozen items cold during transport.

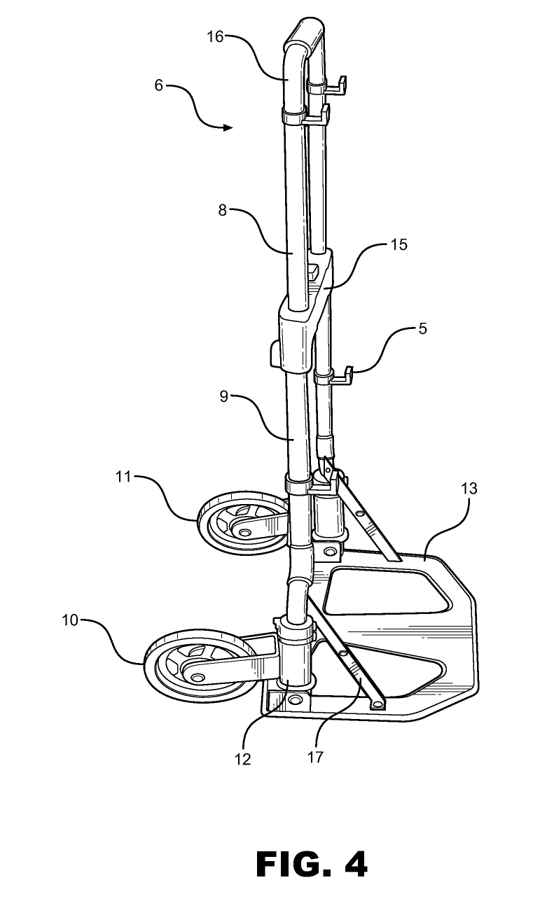

Referring now to FIG. 4, there is shown a side view of the collapsible hand cart 6 in its working configuration. Two parallel lower rails 9 extend vertically and terminate at a junction box 15. Two parallel upper rails 8 extend above the junction box 15, bend toward each other and meet to form a U-shaped handle 16 for the user to handle the cart. Two sets of latches 5 are attached to the cart 6, one on each of the lower rails 9 and one on each of the upper rails 8. These latches mate to the profile of the rails and are securely fastened in place. The upper rails 8 are narrower in outer diameter than the inner diameter of the lower rails 9 to permit the upper rails 8 to slide inside the inner diameter of the lower rails 9 for collapsibility. Upper rails 8 are secured into place while in their working, extended position. When collapsing, the user releases the securing means and pushes down on the handle 16, forcing the upper rails 8 to be inserted into the lower rails 9.

Two wheels 10 and 11 are rotatably mounted to the lower rails 9. The wheels 10 and 11 are capable of rotation about their center point, which permits the wheels to roll and the cart to move. The wheel attachment brackets 12 are rotatably mounted to the lower rails 9 to allow the wheels 10 and 11 to rotate inwards for collapsing the hand cart 6. The base platform 13 is shown in its extended position, and is supported by a support brace 17. The base platform 13 can fold towards the lower rails 9 when not in use. Together, the upper rails 8, wheel attachment brackets 12, and the base platform 13 can fold together to permit collapsing of the cart 6.

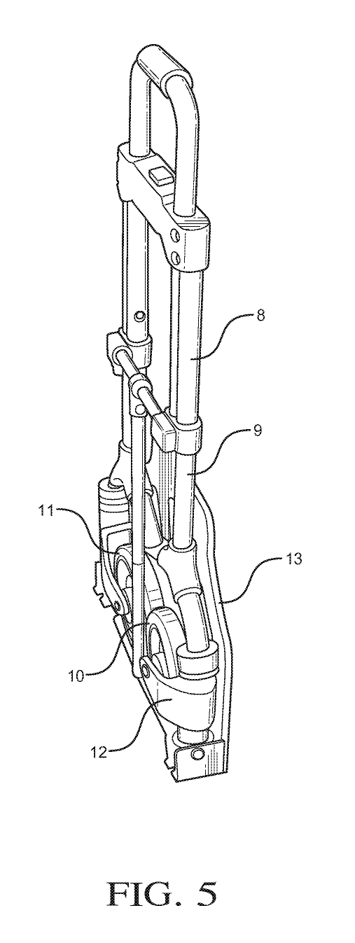

Referring now to FIG. 5, there is shown an angled view of the hand cart in its collapsed position. As described above, the base platform 13 is folded towards the lower rails 9, the wheels 10 and 11 are folded inward, and the upper rails 8 are condensed into the lower rails 9. This configuration provides a compact configuration for storing and transporting the cart when not in use.

In use an individual uses the market basket system as a method to replace store-owned shopping carts and environmentally harmful grocery bags. The conscious shopper can employ the market baskets in conjunction with the hand cart to grocery shop in a manner that produces no environmentally harmful waste, while also reducing cost for the consumer and the store. This method of shopping illuminates the cost of the bags, the cost of the shopping carts and the cost of paying someone to collect the shopping carts after their use.

The market baskets can also be used independently from the hand cart if a store-owned cart is preferred, or if fewer items are needed to be purchased. The basket handles allow the user to carry items with one hand, or they can be placed inside the grocery cart to organize and separate food. After check-out, the baskets are useful for supporting the items in a vehicle and preventing them from falling or spilling out. Optional cloth or insular liners are capable of being incorporated into the baskets as well.

Using the market baskets in conjunction with the hand cart is also helpful for those that live in urban areas, where transporting goods from the market is difficult in one trip. Multiple paper or plastic bags are difficult to carry over long distances, and often necessitates several trips to bring all items into the home. The hand cart reduces this stress, and improves transportability of multiple items. The baskets can carry heavy loads, while the two-wheeled cart can traverse long distances, uneven terrain, and even steps if necessary. A smaller person can also move larger loads with less personal strain and anxiety.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A modular basket system for collecting and organizing items in a grocery cart, comprising:
one or more rigid baskets with a rectangular opening and a forward and rear side, a folded lip at said opening, two handles that pivotably attach to said forward and rear side, and an attachment bar fixed to said rear side.

2) A modular basket system for collecting and organizing items and attached to a collapsible hand cart, comprising:
one or more rigid baskets with a rectangular opening and a forward and rear side, a folded lip at said opening, two handles that pivotably attach to said forward and rear side, and an attachment bar fixed to said rear side;
two parallel lower rails that connect to two upper rails, said upper rails form a U-shaped handle, said upper rails are collapsible inside said lower rails, four latch devices attach to said upper and lower rails to mate with said U-shaped bars of said rigid baskets to support load;
two wheels pivotably attach to said lower rails, and a base platform extends perpendicular to said lower rails, said wheels and said base platform fold toward said lower rails to condense said hand cart.

3) A method of shopping, comprising the steps of:
using one or a plurality of rigid baskets to shop for groceries or retail items without using store-provided shopping bags,
utilizing said baskets to organize and separate said groceries within a store-owned shopping cart.

4) A method as recited in claim 3, in which said baskets are lined with fabric bags.

5) A method as recited in claim 4, in which said liners are thermal insulators to keep frozen items cold for long periods of time.

6) (canceled)

7) (canceled)

8) (canceled)
